(19) United States
(12) Patent Application Publication
(10) Pub. No.: US 2007/0122215 A1
(43) Pub. Date: May 31, 2007

(54) Fixing device for an image forming apparatus

(75) Inventors: Jeonghwa Kim, Suwon-si (KR); Dong-jin Seol, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/385,776

(22) Filed: Mar. 22, 2006

(30) Foreign Application Priority Data
Nov. 25, 2005 (KR) 2005-0113600

(51) Int. Cl. G03G 15/20

(52) U.S. Cl. 399/329

(57) ABSTRACT

A fixing device of an image forming apparatus includes a heating roller, a pressing roller forming a first fixing nip by contacting the heating roller, and a pressing member disposed at a lower stream of the heating roller and forming a second fixing nip by contacting the heating roller. A fixing belt runs along a caterpillar track, and winds around the pressing roller and the pressing member. The pressing member includes a protrusion part for pressing the paper passed through the second fixing nip by greater pressure at a nip outlet than at the second fixing nip. Accordingly, as the width of the fixing nip is increased, the staying time at the fixing nip increases, thereby improving printing quality according to performance of high-speed printing. Additionally, wrap jams of the paper may be substantially prevented from occurring at the nip outlet.

### CROSS-REFERENCE TO RELATED APPLICATIONS

This application claims the benefit under 35 U.S.C. § 119(a) of Korean Patent Application No. 2005-113600, filed Nov. 25, 2005, the entire contents of which are hereby incorporated by reference.

### BACKGROUND OF THE INVENTION

1. Field of the Invention

The present invention relates to an image forming apparatus. More particularly, the present invention relates to a fixing device for an image forming apparatus that fuses and fixes a toner image onto a paper.

2. Description of the Related Art

Generally, image forming apparatuses, such as printers, scanners, copiers, and multifunction peripherals (MFP), include a fixing device for fixing developer, for example, a toner image, transferred onto the paper by a general transferring device.

FIG. 1 is a sectional view schematically showing a conventional fixing device of an image forming apparatus.

As shown in FIG. 1, the conventional fixing device includes a heating roller 10 and a pressing roller 20 rotated in contact with each other. The heating roller 10 includes therein a heat source 11, such as a heating coil for generating heat for fixing the toner image onto the paper permanently. Additionally, a temperature sensor (not shown) is contactedly or non-contactedly formed on the surface of the heating roller 10 to detect temperature of the heat source 11.

While paper 1 passes through a nip a formed by contact between the heating roller 10 and the pressing roller 20, the above-structured fixing device heats and presses an unfixed toner image 1′ transferred on the paper 1, thereby fixing the unfixed toner image 1′ onto the paper. The temperature sensor mounted on the outside of the heating roller 10 detects the temperature of the heating roller 10. A control unit (not shown) controls the temperature of the heating roller 10 by turning on and off the heat source 11.

In response to a demand for high-speed operation of the image forming apparatus, an outer diameter of a fixing roller needs to be increased. This expands the width of the nip because the fixing quality deteriorates due to a decreased staying time of the paper at the nip as the printing speed increases. However, increasing the diameter of the roller is limited. Also, as the roller diameter increases, warming-up time and the manufacturing costs also increase.

Even in the high-speed image forming apparatus, the fixing quality may be ensured by increasing the pressure applied to the nip. However, too much pressure at the nip deteriorates the durability of the fixing device. Furthermore, paper jams will occur more frequently because the paper cannot move smoothly. Moreover, as driving torque increases, the apparatus may be damaged. Referring to the curve identified by \textcircled{1} of FIG. 3, distribution of the pressure at the nip in the conventional fixing device is symmetrical between a nip inlet and a nip outlet. Therefore, when the paper whereon the image is fixed passes through the nip outlet, a printed side of paper may roll up adhering to the surface of the heating roller 10, which is called a ‘wrap jam’.

Accordingly, a need exists for an image forming apparatus having an improved fixing device in which the width of the fixing nip is increased to improve print quality.

### SUMMARY OF THE INVENTION

Accordingly, an aspect of the present invention is to provide a fixing device for an image forming apparatus adapted to improve the fixing quality according to high-speed printing by increasing the width of a fixing nip.

Another aspect of the present invention is to provide a fixing device for an image forming apparatus that substantially prevents wrap jams from occurring at a nip outlet after image fixing.

A fixing device for an image forming apparatus includes a heating roller, a pressing roller rotated in tight contact with the heating roller, and a pressing member mounted corresponding to the heating roller and contacted with the heating roller. A fixing belt winds around the pressing member and moves along a caterpillar track.

The pressing member is disposed at a predetermined distance from a rear portion of the heating roller.

The pressing member is configured in a manner that one side surface thereof facing and contacting the heating roller has a corresponding form to a surface of the heating roller and the other side surface thereof is bent to be inscribed in the fixing belt to apply tension to the fixing belt.

The pressing member includes a protrusion part formed on a rear end of the one side surface thereof.

The pressing member includes a resilient member contacting an inner surface of the fixing belt. A support member supports the resilient member.

According to a first exemplary embodiment of the present invention, the support member may be a bent member having a clamp form, and the bent portion protrudes to press the heating roller.

According to a second exemplary embodiment of the present invention, the support member may include a first member facing the heating roller by one side surface thereof; and a second member connected to a rear end of the first member and having a protruded end for pressing the heating roller.

A fixing device according to another exemplary embodiment of the present invention includes a heating roller, a pressing roller forming a first fixing nip by contacting the heating roller, and a pressing member disposed at a lower stream of the heating roller and forming a second fixing nip by contacting the heating roller. A fixing belt runs along a caterpillar track, and winds around the pressing roller and the pressing member. The pressing member includes a protrusion part for pressing the paper passing through the second fixing nip with a greater pressure at a nip outlet than at the second fixing nip.

The pressing member includes a resilient member contacting an inner surface of the fixing belt. A support member supports the resilient member.

The support member is bent to include first and second members arranged substantially perpendicularly to each other. The protrusion part is formed at a corner between the first and the second members.

The support member includes first and second members connected substantially perpendicularly to each other. The protrusion part is formed at a corner between the first and the second members. The protrusion part is formed by connecting the first and second members such that one end of the first and second members deviate from each other.

The resilient member includes one of silicon rubber, urethane, and foamed resin.

The resilient member is applied with lubricant on one side contacting the fixing belt.

The support member includes metal.

Other objects, advantages and salient features of the invention will become apparent from the following detailed description, which, taken in conjunction with the annexed drawings, discloses exemplary embodiments of the invention.

### BRIEF DESCRIPTION OF THE DRAWING FIGURES

The above aspect and other features of the present invention will become more apparent by describing in detail exemplary embodiments thereof with reference to the attached drawing figures, wherein;

FIG. 1 is a sectional view schematically showing a conventional fixing device of an image forming apparatus;

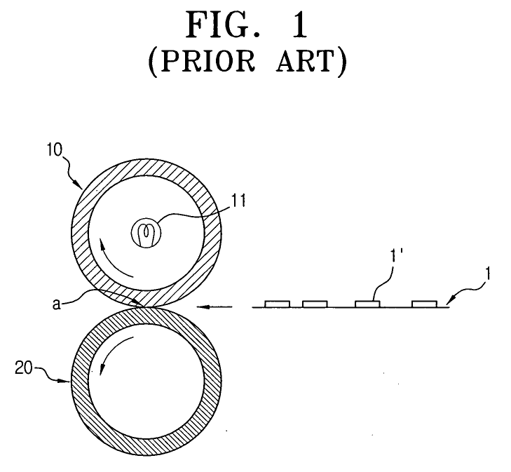

FIG. 2A is an elevational view in partial cross section of a fixing device of an image forming apparatus according to a first exemplary embodiment of the present invention;

FIG. 2B is an elevational view in partial cross section of a fixing device of an image forming apparatus according to a second exemplary embodiment of the present invention; and

FIG. 3 is a graph illustrating pressure distribution at a fixing nip of the fixing device according to an exemplary embodiment of the present invention.

Throughout the drawings, like reference numerals will be understood to refer to like parts, components and structures.

### DETAILED DESCRIPTION OF EXEMPLARY EMBODIMENTS

Hereinafter, exemplary embodiments of the present invention will be described in detail with reference to the accompanying drawing figures.

The matters defined in the description, such as a detailed construction and elements thereof, are provided to assist in a comprehensive understanding of the invention. Thus, it is apparent that the present invention may be carried out without those defined matters. Also, well-known functions or constructions thereof are omitted to provide a clear and concise detailed description.

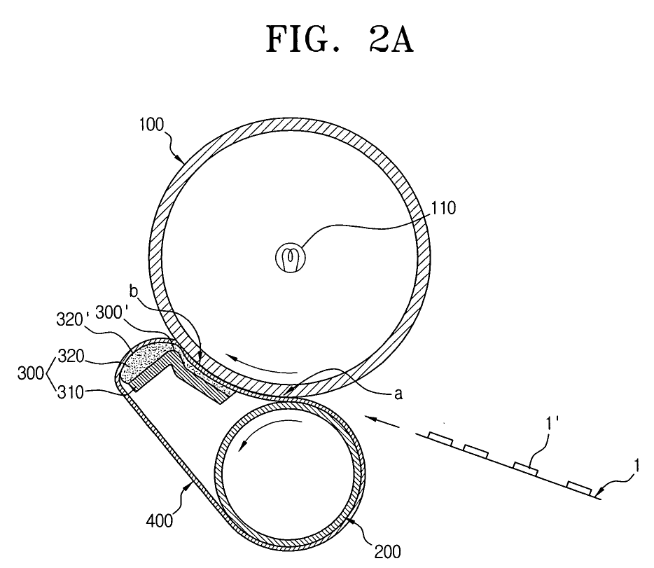

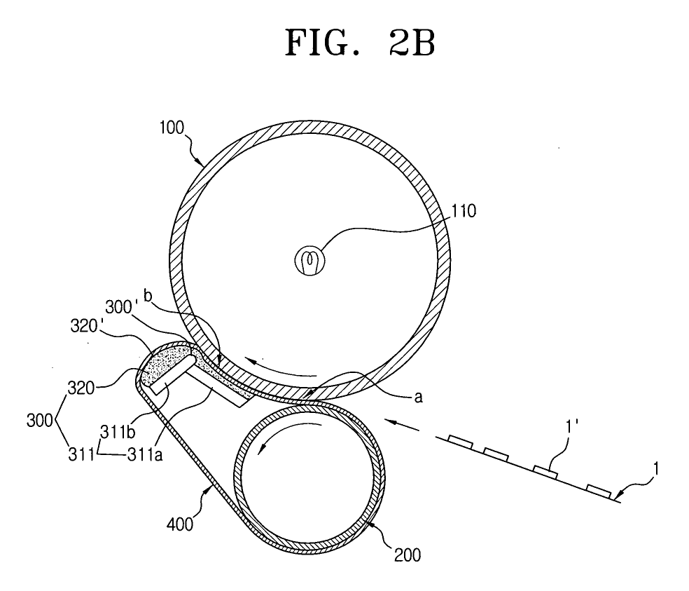

FIG. 2A is an elevational view in partial cross section of a fixing device of an image forming apparatus according to a first exemplary embodiment of the present invention.

As shown in FIG. 2A, the fixing device of the image forming apparatus includes a heating roller 100, a pressing roller 200, a pressing member 300, and a fixing belt 400.

Being substantially shaped as a cylindrical roller, the heating roller 100 includes therein a heat source 110, such as a heating coil, for generating heat for fixing a toner image 1′ onto paper 1 permanently.

The pressing roller 200 is substantially formed as a cylindrical roller and arranged substantially parallelly with the heating roller 100. The pressing roller 200 rotates in contact with the heating roller 100, thereby forming a first fixing nip a.

Since structure and operation of the heating roller 100 and the pressing roller 200 are generally known, a detailed description thereof is omitted.

The pressing member 300 is mounted at a predetermined distance from a rear portion of the pressing roller 200 and contacts the heating roller 100, thereby forming a second nip b. The pressing member 300 includes a protrusion part 300′ formed at a rear end of one side surface thereof that faces and contacts the heating roller 100. Also, the pressing member 300 is bent so that the other side surface thereof is disposed within the fixing belt 400 and thereby applies tension to the fixing belt 400. The pressing member 300 includes a resilient member 320 contacting an inner surface of the fixing belt 400, and a support member 310 supporting the resilient member 320. Preferable, the resilient member 320 and the fixing belt 400 are applied with a lubricant, respectively, on a surface for contacting with each other.

The support member 310 is a bent member having a clamp form and pressed by a spring (not shown). The bent portion protrudes to press the heating roller 100. The support member 310 has one side curved substantially corresponding to the circumference of the heating roller 100 to contact the circumference of the heating roller 100, thereby securing a certain width of the second fixing nip b. According to a second exemplary embodiment of the present invention, as shown in FIG. 2B, a support member 311 includes a first member 311a facing the heating roller 100 with one side surface thereof, and a second member 311b connected to a rear end of the first member 311a and having a protruded end for pressing the heating roller 100. Preferably, the resilient member 320 has an arc section 320′ behind the second fixing nip b to smoothly guide running of the fixing belt 400. At the second fixing nip b, the resilient member 320 is curved to substantially correspond to the surface of the heating roller 100 to secure width and pressure of the second fixing nip b. The support member 310 may be formed of a robust material, such as general carbon steel, stainless steel, aluminum, aluminum alloy, or ceramics. The resilient member 320 may be formed of silicon rubber, urethane, or foamed resin.

The fixing belt 400 runs along a caterpillar track and winds around the pressing roller 200 and the pressing member 300.

Although not shown, the fixing device according to the exemplary embodiments of the present invention may include a temperature sensor for detecting the temperature of the heating roller 100 and a control unit for controlling the temperature of the heating roller 100 detected by the temperature sensor.

The fixing device of the image forming apparatus, according to the exemplary embodiments of the present invention includes the pressing member 300 disposed behind the heating roller 200, which rotates in tight contact with the heating roller 100 and pressingly contacts the heating roller 100. According to this configuration, the first fixing nip a is formed by contact between the heating roller 100 and the pressing roller 200, and the second nip b is formed between the heating roller 100 and the pressing member 300. Accordingly, the width of the fixing nip may be efficiently increased. Therefore, as paper 1 is fed to the fixing device passing through the first fixing nip a and the second fixing nip b, an unfixed toner image 1′ transferred on the paper 1 by a transferring device is heated and pressed, thereby being fixed onto the paper 1. Here, with the same printing conditions as in the conventional fixing device, because the widened fixing nip increases the staying time of the paper 1 at the fixing nip, printing quality may be improved even during high-speed printing.

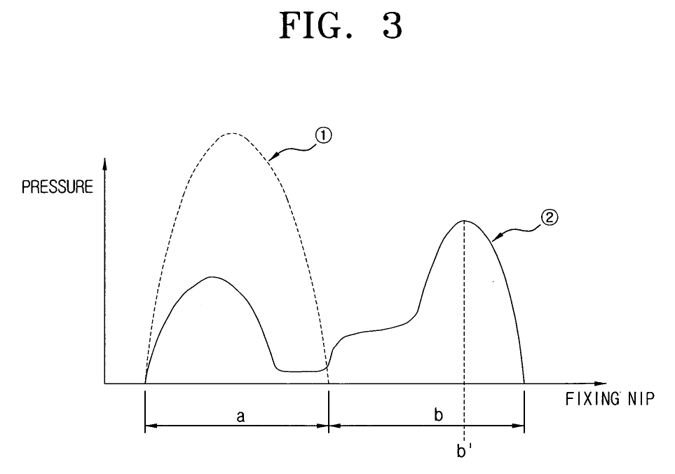

As shown by the curve identified by \textcircled{2} in FIG. 3, pressures applied to the first and the second fixing nips a and b are distributed unsymmetrically. Especially, because the pressing member 300 includes the protrusion part 300′ formed on the rear end of one side surface thereof that contacts the heating roller 100, the paper 1 that has passed through the second nip b is applied with greater pressure at the nip outlet b′ than at the second nip b. As a consequence, the paper 1 passed through the fixing device is forwarded to the fixing belt 400 and accordingly, wrap jams may be substantially prevented.

As may be appreciated from the above description of the exemplary embodiments of the present invention, as the width of the fixing nip is increased, the staying time at the fixing nip increases, thereby improving printing quality according to performance of high-speed printing. Additionally, wrap jams of the paper 1 may be substantially prevented from occurring at the nip outlet b.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A fixing device for an image forming apparatus, comprising:
a heating roller;
a pressing roller rotated in tight contact with the heating roller;
a pressing member mounted corresponding to the heating roller and pressingly contacted with the heating roller; and
a fixing belt running along a caterpillar track, winding around the pressing roller and the pressing member.

2. The fixing device of claim 1, wherein
the pressing member is disposed at a predetermined distance from a rear portion of the heating roller.

3. The fixing device of claim 2, wherein
the pressing member has one side surface thereof facing and contacting the heating roller that has a corresponding form to a surface of the heating roller and the other side surface thereof is bent to be disposed in the fixing belt to apply tension to the fixing belt.

4. The fixing device of claim 3, wherein
a protrusion part is formed on a rear end of the one side surface of the pressing member.

5. The fixing device of claim 4, wherein the pressing member includes
a resilient member contacting an inner surface of the fixing belt.

6. The fixing device of claim 5, wherein the pressing member includes
a support member supporting the resilient member.

7. The fixing device of claim 6, wherein
the support member is a bent member having a substantially L-shape, and the bent portion is protruded to press the heating roller.

8. The fixing device of claim 5, wherein the support member includes
a first member facing the heating roller by one side surface thereof; and
a second member connected to a rear end of the first member and having a protruded end for pressing the heating roller.

9. The fixing device of claim 5, wherein
the resilient member is made of at least one material selected from the group consisting of silicon rubber, urethane, and foamed resin.

10. The fixing device of claim 5, wherein
the resilient member is applied with lubricant on the side contacting the fixing belt.

11. The fixing device of claim 6, wherein
the support member is made of at least one material selected from the group consisting of general carbon steel, stainless steel, aluminum, aluminum alloy, and ceramics.

12. A fixing device for an image forming apparatus, comprising:
a heating roller;
a pressing roller forming a first fixing nip by contacting the heating roller;
a pressing member disposed at a lower stream of the heating roller and forming a second fixing nip by contacting the heating roller;
a fixing belt running along a caterpillar track, and winding around the pressing roller and the pressing member; and
a protrusion part of the pressing member pressing paper passing through the second fixing nip by greater pressure at a nip outlet than at the second fixing nip.

13. The fixing device of claim 12, wherein the pressing member includes
a resilient member contacting an inner surface of the fixing belt; and
a support member supporting the resilient member.

14. The fixing device of claim 13, wherein
the support member is bent to have first and second members arranged approximately perpendicularly to each other.

15. The fixing device of claim 14, wherein
the protrusion part is formed at a corner between the first and the second members.

16. The fixing device of claim 13, wherein
the support member includes first and second members connected approximately perpendicularly to each other, and the protrusion part is formed at a corner between the first and the second members.

17. The fixing device of claim 16, wherein
the protrusion part is formed by connecting the first and the second members such that ends of the first and the second members are deviated from each other.

18. The fixing device of claim 13, wherein
the resilient member is made of at least one material selected from the group consisting silicon rubber, urethane, and foamed resin.

19. The fixing device of claim 13, wherein
the resilient member is applied with lubricant on a side contacting the fixing belt.

20. The fixing device of claim 13, wherein
the support member is made of at least material selected from the group consisting of general carbon steel, stainless steel, aluminum, aluminum alloy, and ceramics.
